(19) United States
(12) Patent Application Publication
(10) Pub. No.: US 2018/0104981 A1
(43) Pub. Date: Apr. 19, 2018

(54) SYSTEMS AND METHODS FOR ATTACHING A PLATE TO A VEHICLE

(71) Applicant: Tire Safety Plates LLC, Elon, NC (US)

(72) Inventors: Jensen Roll, Burlington, NC (US); Daniel Cox, Elon, NC (US)

(21) Appl. No.: 15/292,993

(22) Filed: Oct. 13, 2016

(51) Int. Cl. B60B 7/14; B60B 7/18; B60B 7/00; B60B 5/02; F16B 35/04; F16B 37/00; F16B 39/22

(52) U.S. Cl. CPC B60B 7/14; B60B 7/18; B60B 7/008; B60B 2900/50; F16B 35/04; F16B 37/00; F16B 39/22; B60B 5/02

(57) ABSTRACT

A system for attaching a plate to a vehicle is provided. The system includes lug nuts and lug bolts for attaching the plate to a threaded wheel stud. The lug nuts each define a threaded stud recess for engagement with a threaded wheel stud and a threaded bolt recess for engagement with a threaded portion of a lug bolt. The lug bolts each define a head for rotating the threaded portion of the lug bolt into the bolt recess of the lug nut, a shaft positioned between the threaded portion and the head, and a rotatable portion. The rotatable portion defines a center aperture freely rotatable about the shaft and a bolt aperture for accepting a fastener. A lock nut is positioned about each of the lug bolts for locking the lug bolt into position relative to the lug nut.

### TECHNICAL FIELD

The present disclosure relates generally systems and methods for attaching a plate to a vehicle. More specifically, the present disclosure relates to attaching a plate and safety wheel to the tire mount of a vehicle.

### BACKGROUND

There are numerous reasons to attach a device or object to the tire mount of a vehicle. Sensors for detecting road conditions or features are useful, particularly as the shift towards more automation progresses. Further, back-up tires or safety wheels may be desired to minimize risk in case of tire damage. One issue with the prior art is that each accessory must be specifically designed for the vehicle on which it is attached. For example, U.S. Pat. No. 6,217,125 filed Feb. 16, 1999 and issued Apr. 17, 2001, and U.S. Patent Application Publication 2014/0084670 filed Sep. 21, 2012 and published Mar. 27, 2014 both disclose safety wheel for attaching to a tire mount.

In each of these disclosures, the safety wheel includes a central disc or hub that is specifically designed to attach to the specific lug pattern of the vehicle. This creates significant manufacturing challenges as a unique accessory (e.g., safety wheel) must be designed for each unique lug pattern. Even vehicle tire mounts with the same amount of lugs may have different lug patterns.

There remains a need for system and method of attaching a plate to a vehicle which is interchangeable amongst differing lug patterns. Disclosed herein are one or more devices and methods that advantageously address these issues.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a system for attaching a plate to a vehicle is provided. The system includes lug nuts each defining a threaded stud recess for engagement with a threaded wheel stud, and a threaded bolt recess for engagement with a threaded portion of a lug bolt. The system further includes the lug bolts each defining a head for rotating the threaded portion of the lug bolt into the bolt recess of the lug nut, a shaft positioned between the threaded portion and the head, a rotatable portion, and a lock nut positioned about each of the lug bolts for locking the lug bolt into position relative to the lug nut. The rotatable portion defines a center aperture freely rotatable about the shaft, and a bolt aperture for accepting a fastener.

According to at least one embodiment, a method of attaching a plate to a vehicle is provided. The method includes: threading a stud recess of a lug nut about a threaded wheel stud; rotating a head of a lug bolt for threading a threaded portion of the lug bolt into a bolt recess of the lug nut; affixing the position of the lug bolt relative to the lug nut by rotating a lock nut about the threaded portion and into engagement with the lug nut; repeating the previous three steps for additional lug nuts and additional lug bolts; rotating a rotatable portion of each of the lug bolts for aligning an aperture defined by the rotatable head with a corresponding arcuate slot defined by a plate; and securing the plate to the lug bolts by inserting a plate fastener through each arcuate slot and the corresponding aperture for securing the plate to the vehicle.

According to another embodiment, the shafts include a recessed portion about which the rotatable head rotates.

According to another embodiment, the lug nut includes a tapered end which is conical-shaped or rounded for engagement with the vehicle.

According to another embodiment, the system further includes threaded wheel studs for being accepted by a threaded hole of the vehicle.

According to another embodiment, the rotatable head defines a washer portion extending radially from the center aperture for rotating about the shaft, and a mounting portion extending perpendicularly from an end of the washer portion distal from the center aperture, the mounting portion defining the bolt aperture.

According to another embodiment, each head is wholly positioned within the mounting portion and accessible for rotation by a tool.

According to another embodiment, the system further includes extensions defining a threaded extension and a threaded extension recess, wherein the engagement of the lug bolts to the lug nuts includes: engagement of the threaded portion of the lug bolt to the extension recess, and engagement of the extension bolt to the bolt recess of the lug nut.

According to another embodiment, the system further includes a plate defining an arcuate slot corresponding to each lug bolt and plate fasteners for selectively engaging the plate to each lug bolt by extension through one of the arcuate slots and a corresponding bolt aperture.

According to another embodiment, the system further includes a plate fastener nut for securing the plate to the rotatable portion of the lug bolt.

According to another embodiment, the system further includes including a safety wheel defining wheel apertures corresponding to plate apertures defined by the plate for selectively engaging the safety wheel to the plate by extension of a wheel fastener through one of the wheel apertures and a corresponding plate aperture.

According to another embodiment, the wheel apertures are defined by a middle portion of the safety wheel, the safety wheel further including a rim portion positioned orthogonally and about an outer circumference of the middle portion.

According to another embodiment, the rim portion is comprised of rubber and/or polymer.

According to another embodiment, the rim portion includes spikes extending radially therefrom.

According to another embodiment, the rim portion includes ridges extending across a width of the rim and radially therefrom.

According to another embodiment, the middle portion includes cutouts for permitting airflow therethrough.

According to another embodiment, the rotating the head of the lug bolt includes engaging the threaded portion of the lug nut with an extension recess of an extension, the extension defining an extension bolt engaged with the bolt recess of the lug nut.

According to another embodiment, the method further includes securing a safety wheel to the plate by inserting a wheel fastener through each of a plurality of wheel apertures and each of a corresponding plate aperture.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a side view of the system for attaching the plate to a vehicle according to one or more embodiments of the present invention.

FIG. 2 is a front view of the lug bolt according to one or more embodiments of the present invention.

FIG. 3 is a front view of the plate according to one or more embodiments of the present invention.

FIG. 4 is a perspective view of the safety wheel having ridges according to one or more embodiments of the present invention.

FIG. 5 is a side view of the safety wheel, wheel fastener and lug nuts according to one or more embodiments of the present invention.

FIG. 6 is a perspective view of the safety wheel engaged with the wheel of a vehicle according to one or more embodiments of the present invention.

FIG. 7 is a front view of the plate, an arm and a sensor according to one or more embodiments of the present invention.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

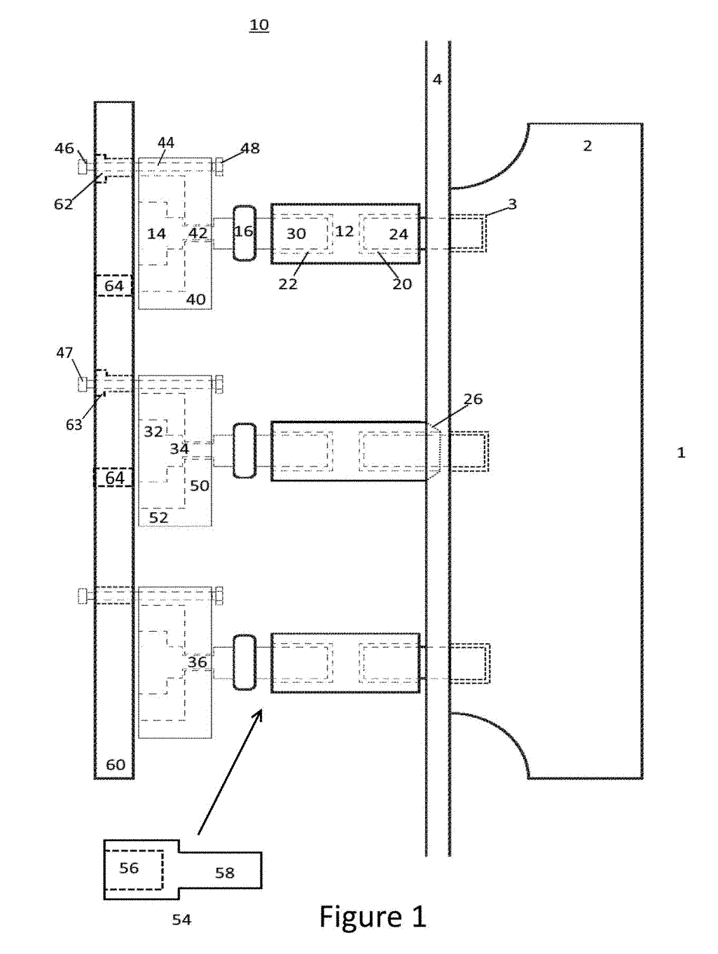

FIG. 1 depicts a system 10 for attaching a plate 60 and/or another item to a vehicle 1. The vehicle 1 includes a wheel mount 2 to which a rim 4 of a wheel 5 may be secured. The wheel mount 2 may define a plurality of wheel holes 3 into which a wheel stud 24 may be engaged. Alternatively, the wheel mount 2 may define a plurality of wheel studs 24 protruding therefrom. The wheel studs 24 may extend through the rim 4 of a wheel and/or may be selectively engageable with one or more varieties of lug nuts 12. The wheel studs 24 may be included by the vehicle 1 and/or the system 10.

The system 10 of FIG. 1 for attaching a plate 60 to a vehicle 1 may comprise one or more lug nuts 12 and/or one or more lug bolts 14. Each lug nut 12 may define a stud recess 20 for engagement with a wheel stud 24. Each lug nut 12 may further define a bolt recess 22 for engagement with a threaded portion 30 of a lug bolt 14. Any of the lug nuts 12, stud recesses 20, wheel studs 24 and/or lug bolts 14 may be threaded partially or completely. Any type of threading may be provided. The lug nut 12 may define a tapered end 26 which is conical-shaped or rounded for engagement with the vehicle 1, wheel hole 3 and/or wheel rim 4. The tapered end 26 may provide a more secure and stable engagement, useful when carrying loads at high rotational speeds.

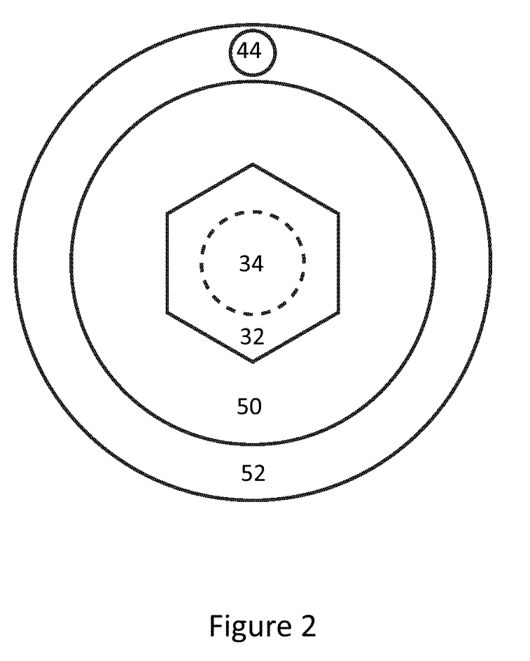

The lug bolts 14 may each define a head 32 for rotating the threaded portion 30 of the lug bolt 14 into the bolt recess 22 of the lug nut 12 (FIGS. 1 and 2). A shaft 34 may be positioned between the threaded portion 30 and the head 32 of the lug bolt 14. The lug bolt 14 may also include a rotatable portion 40 for permitting free rotation of the rotatable portion 40 in relation to the shaft 34. A center aperture 42 may be defined by the rotatable portion 40 for providing free rotation of the rotatable portion 40 about the shaft 34 of the lug bolt 14. Further, each shaft 34 may define a recessed portion 36 about which the center aperture 42 of the rotatable portion 40 rotates. The center aperture 42 may be sized and shaped for ensuring that the rotatable portion 40 is positioned proximately to the recessed portion 36 for preventing the rotatable portion 40 from translating along the shaft 34 outside of the recessed portion 36 (see, e.g., FIG. 1).

The rotatable portion 40 may further define a washer portion 50 extending radially from the center aperture 42 for rotating about the shaft 34. The washer portion 50 may be substantially perpendicular to the shaft 34 of the lug bolt 14. The rotatable portion 40 may further define a mounting portion 52 extending at an angle from the washer portion 50. For example, the mounting portion 52 may extend substantially perpendicular from an end of the washer portion 50 distal from the center aperture 42. The mounting portion 52 may define the bolt aperture 44.

As is depicted by FIG. 1, each head 32 of the lug bolt 14 may be wholly positioned within the mounting portion 52 and accessible for rotation by a tool. For example, the tool may be a standard socket wrench. In some embodiments, the head 32 may align with the mounting portion 52 for forming a plane onto which a plate 60 or item may be selectively engaged. For example, referring to the illustration in FIG. 1, each of the heads 32 and mounting portions 52 depicted form a plane onto which the plate 60 is engaged, thereby providing additional support to the plate 60 when selectively fastened to the vehicle 1. In one method of using the system 10, a planar surface, such as a ruler, a flat item or the plate 60 itself, may be used to align each of the lug nuts 14 planarly.

The rotatable portion 40 of the lug bolt 14 may further define a bolt aperture 44 for accepting a plate fastener 46. Any number of plate fasteners 46 may be used. For example, a threaded bolt may be used as a plate fastener 46. Both the bolt aperture 44 and the plate fastener 46 may be threaded. The system 10 may include a plate fastener nut 48 for selectively securing the plate fastener 46 to the rotatable portion 40.

The system 10 may further include a plate 60 defining an arcuate slot 62 corresponding to each lug bolt 14. The plate fasteners 46 may selectively engage the plate 60 to each lug bolt 14 by extension through one of the arcuate slots 62 and the corresponding bolt aperture 44. In such an embodiment, the system 10 may include a plate fastener nut 48 for securing the plate 60 to the rotatable portion 40 of the lug bolt 14. In other embodiments, the arcuate slots 62 may define a recessed slot portion 63 for accepting a head 47 of the plate fastener 46. The head 47 of the plate fastener 46 may then rest wholly within the recessed slot portion 63 and/or may form a plane with the surface of the plate 60. The head 47 may snuggly fit within the recessed slot portion 63 for restricting rotation of the head 47.

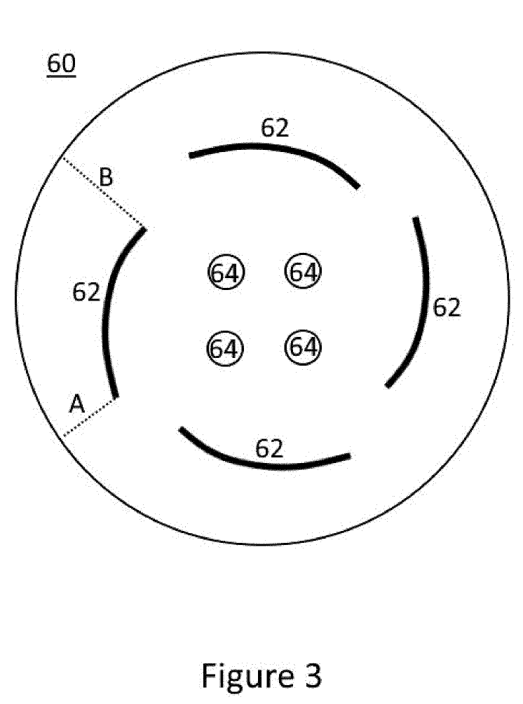

The plate 60 may include any number of plate apertures 64 extending through the plate 60 for permitting selective fastening of an item or safety wheel 70 thereto. For example, in FIG. 3, the four plate apertures 64 are centrally located and symmetrically spaced. Other configurations may be provided for more easily fastening any number of items. The arcuate slots 62 may be arranged in any number of configurations as well for selectively fastening the plate 60 to the vehicle 1. In FIG. 3, the four arcuate slots 62 are symmetrically arranged. In other embodiments, any number of arcuate slots 62 may be provided. The arcuate slots 62 depicted are also arcs of a circle slightly biased on one end centrally for providing a range of slot positions to which the fastener 46 may attach the plate 60 to the lug bolt 14. In FIG. 3, the distance from the circumference of the plate 60 is greater at point B than at point A, thereby allowing any distance between point A and B to be used. In another embodiment, the arcuate slots 62 may be substantially linear, such that the arc is one of an infinitely large circle. The rotatable portion 40 of the lug bolt 14 may be rotated to align the bolt aperture 44 and the corresponding arcuate slot 62 for selective fastening.

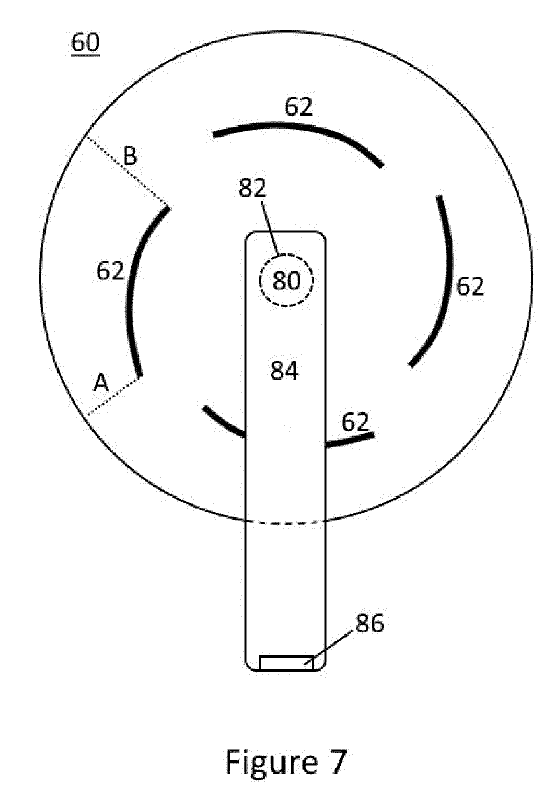

In an alternative embodiment, as depicted in FIG. 7, the plate 60 may have an attachment 80 extending therefrom. The attachment 80 may be permanently affixed to the plate 60 or may be selectively engaged with the plate 60. The selective engagement of the attachment 80 may be to a plate aperture 64. The extension of the attachment 80 from the plate may be substantially perpendicular in relation to the plate or the attachment 80 may extend at an angle from the plate 60. The attachment 80 may extend from any portion of the plate 60.

In one embodiment, the attachment 80 may extend perpendicularly from a center of the plate 60, as depicted in FIG. 7, wherein rotation of the plate 60 by the vehicle 1 may also rotate the attachment 80 about the attachment's center axis. The attachment 80 may be coupled, or selectively fastened, to an arm 84. The arm 84 may carry any number of accessories 86, such as light(s), sensor(s) or decal(s), for example. In some embodiments, it may be desired to have the arm 84 continually hang vertically from the attachment 80 to the ground beneath the vehicle 1. In such an embodiment, the engagement 82 of the arm 84 with the attachment 80 may include ball bearings for permitting free rotation of the attachment 80 within the body of the arm 84. Other engagements 82 permitting free rotation of the arm 84 with respect to the attachment 80 may be provided. The engagement 82 may also be fixed. One useful application of such an embodiment would be where sensing the roadway or ground beneath the vehicle 1 is desired, such as with autonomous and semi-autonomous vehicles. A sensor accessory 86 placed on the end of the arm 84 would therefore suspend directly above, and in proximity to, the roadway or ground beneath the vehicle 1. The accessory 86, such as a sensor or sensors, may be in wireless communication with the vehicle 1 or a remotely placed wireless receiver.

In yet another embodiment, the attachment 80 may extend inwardly from the plate 60, towards the vehicle 1 and/or wheel mount 2. A freely hanging arm 84 may therefore extend towards the ground or roadway between the lug nuts 12 and/or lug bolts 14. Therefore, should the engagement 82 disallow perfect free rotation, or should the vehicle 1 create undesirable vibrations or movement, the positioning of the arm 84 between the lug nuts and/or lug bolts 14 may provide limitations to the undesired movement of the arm 84 and/or accessory 86 from their desired position in proximity to the ground or roadway.

The system 10 may further include a lock nut 16 positioned about each of the lug bolts 14 for locking the lug bolt 14 into position relative to the lug nut 12 and/or extension 54. The lock nut 16 may be positioned between the lug nut 12 and the rotatable portion 40 and/or between the extension 54 and the rotatable portion 40. The lock nut 16 may be any type of nut that resists loosening under vibrations and torque, for example. In one embodiment the lock nut 16 may deform and tighten its grip on the lug bolt 14 as it is rotated into engagement with the extension 54 or lug nut 12.

The system 10 may further include extensions 54 defining an extension bolt 58 and an extension recess 56. The extension bolt 58 and the extension recess 56 may be threaded. The engagement of the lug bolts 14 to the lug nuts 12 may include engagement of the threaded portion 30 of the lug bolt 14 to the extension recess 56 and engagement of the extension bolt 58 to the bolt recess 22 of the lug nut 12. The extension bolt 58 may be useful for extending the separation distance between the plate 60 and/or item and the vehicle 1, wheel mount 2, wheel and/or wheel rim 4.

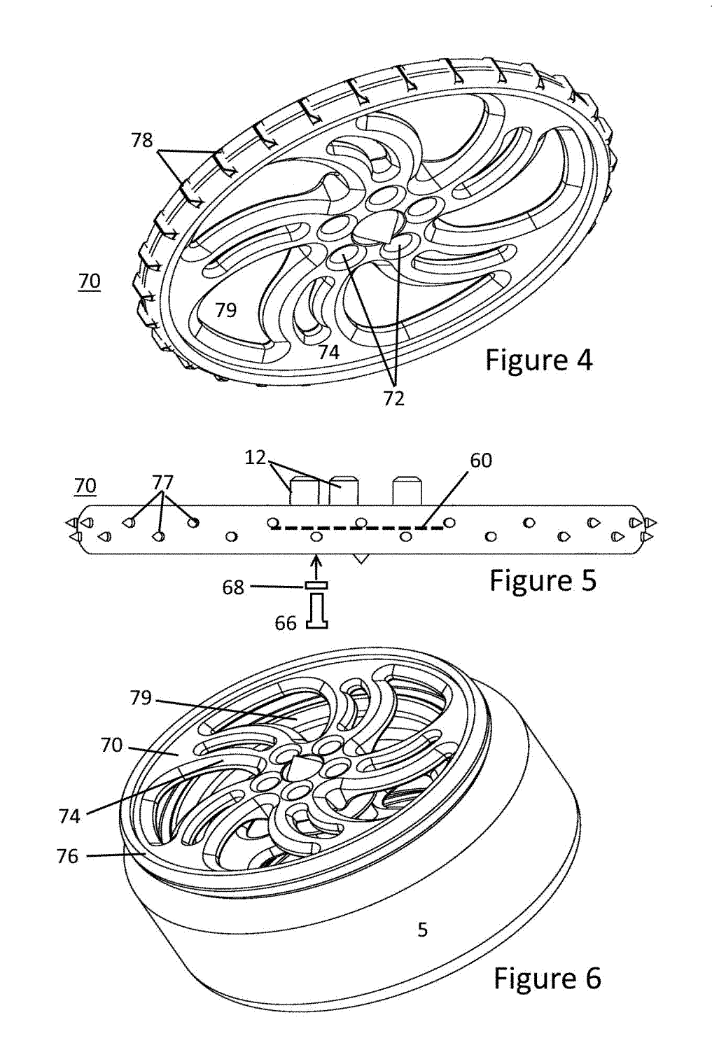

Turning to FIGS. 4 through 6, the system 10 may further include one or more safety wheels 70 according to one or more embodiments of the invention. Each safety wheel 70 may define wheel apertures 72 corresponding to plate apertures 64 defined by the plate 60 for selectively engaging the safety wheel 70 to the plate 60 by extension of a wheel fastener 66 through one of the wheel apertures 72 and a corresponding plate aperture 64. The wheel apertures 72 may be defined by a middle portion 74 of the safety wheel 70. The safety wheel 70 may further include a rim portion 76 positioned orthogonally and about an outer circumference of the middle portion 74. The rim portion 76 may be comprised of rubber and/or polymer. As is depicted in FIG. 6, the rim portion 76 may be bisected by the middle portion 74.

The safety wheel 70 may be fastened to the vehicle 1 during normal operation mode for providing security to passengers if any wheel 5 becomes defective or flat during operation. Alternatively, the safety wheel 70 may be fastened to the vehicle after the wheel 5 becomes defective or flat by lifting the vehicle, then securing the safety wheel 70 to the vehicle 1. The defective or flat wheel 5 may be removed or remain secured to the vehicle 1.

As is depicted by FIG. 5, the rim portion 76 may include spikes 77 extending radially therefrom. As is depicted in FIG. 4, the rim portion 76 may include ridges 78 extending across a width of the rim portion 76 and radially therefrom. The spikes 77 and/or ridges 78 may provide additional traction, which may be useful in adverse conditions, such as ice, snow or mud, for example.

The middle portion 74 may include cutouts 79 for permitting airflow therethrough. Such airflow may help to cool the brakes of the vehicle 1 during use.

A method of attaching an item, such as a safety wheel 70 and/or plate 60, to a vehicle 1 may be provided. The method may include threading a stud recess 20 of a lug nut 12 about a threaded wheel stud 24. Further, a head 32 of a lug bolt 14 may be rotated for threading a threaded portion 30 of the lug bolt 14 into a bolt recess 22 of the lug nut 12. Rotating the head 32 may include engaging the threaded portion 30 of the lug bolt 14 with an extension recess 56 of an extension 54, the extension 54 defining an extension bolt 58 engaged with the bolt recess 22 of the lug nut 12. The method may also include affixing the position of the lug bolt 14 relative to the lug nut 12 or extension 54 by rotating a lock nut 16 about the threaded portion 30 and into engagement with the lug nut 12. These steps may be repeated for additional lug nuts 12 and lug bolts 14.

The method of attaching an item may include rotating a rotatable portion 40 of each of the lug bolts 14 for aligning an aperture 44 defined by the rotatable portion 40 with a corresponding arcuate slot 62 defined by a plate 60. The plate 60 may be secured to the lug bolts 14 by inserting a plate fastener 46 through each arcuate slot 62 and the corresponding aperture 44 for securing the plate 60 to the vehicle 1.

The plate 60 itself may the item attached, or the item may include a safety wheel 70 or some other item, such as a sensor, light, tracking device, or aesthetic item, for example. The safety wheel 70 may be secured to the plate 60 by inserting a wheel fastener 66 through each of a plurality of wheel apertures 72 and each of a corresponding plate aperture 64. Any of the other items may be similarly secured to the plate 60. Alternatively, any of the other items may be secured to the plate 60 using either one or more of the plate apertures 64 and/or arcuate slots 62. For example, a sensor may be secured to a plate 60 using four of the plate apertures, or, alternatively by selectively fastening two item fasteners (not shown) through portions or one or more arcuate slots 62.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

The invention claimed is:

1. A system for attaching a plate to a vehicle, comprising:
lug nuts each defining:
a threaded stud recess for engagement with a threaded wheel stud; and
a threaded bolt recess for engagement with a threaded portion of a lug bolt;
the lug bolts each defining:
a head for rotating the threaded portion of the lug bolt into the bolt recess of the lug nut;
a shaft positioned between the threaded portion and the head;
a rotatable portion defining:
a center aperture freely rotatable about the shaft; and
a bolt aperture for accepting a plate fastener; and
a lock nut positioned about each of the lug bolts for locking the lug bolt into position relative to the lug nut.

2. The system of claim 1, wherein each shaft defines a recessed portion about which the rotatable portion rotates.

3. The system of claim 1, wherein the lug nut includes a tapered end which is conical-shaped or rounded for engagement with the vehicle.

4. The system of claim 1, further comprising threaded wheel studs for being accepted by a threaded hole of the vehicle.

5. The system of claim 1, wherein the rotatable portion defines:
a washer portion extending radially from the center aperture for rotating about the shaft; and
a mounting portion extending perpendicularly from an end of the washer portion distal from the center aperture, the mounting portion defining the bolt aperture.

6. The system of claim 5, wherein each head is wholly positioned within the bolt aperture of the mounting portion and accessible for rotation by a tool.

7. The system of claim 1, further comprising extensions defining a threaded extension bolt and a threaded extension recess, wherein the engagement of the lug bolts to the lug nuts includes:
engagement of the threaded portion of the lug bolt to the extension recess; and
engagement of the extension bolt to the bolt recess of the lug nut.

8. The system of claim 1, further comprising a plate defining an arcuate slot corresponding to each lug bolt, wherein the plate fasteners selectively engaging the plate to each lug bolt by extension through one of the arcuate slots and a corresponding bolt aperture.

9. The system of claim 8, further comprising a plate fastener nut for securing the plate to the rotatable portion of the lug bolt.

10. The system of claim 8, further including a safety wheel defining wheel apertures corresponding to plate apertures defined by the plate for selectively engaging the safety wheel to the plate by extension of a wheel fastener through one of the wheel apertures and a corresponding plate aperture.

11. The system of claim 10, wherein the wheel apertures are defined by a middle portion of the safety wheel, the safety wheel further including a rim portion positioned orthogonally and about an outer circumference of the middle portion.

12. The system of claim 11, wherein the rim portion is comprised of rubber and/or polymer.

13. The system of claim 11, wherein the rim portion includes spikes extending radially therefrom.

14. The system of claim 11, wherein the rim portion includes ridges extending across a width of the rim and radially therefrom.

15. The system of claim 11, wherein the middle portion includes cutouts for permitting airflow therethrough.

16. The system of claim 8, further comprising:
an attachment extending substantially perpendicular from a center of the plate;
an arm coupled to the attachment and extending substantially parallel to the plate;
an accessory carried by the arm,
wherein the coupling of the arm and the attachment permits free rotation of the arm in relation to the attachment.

17. A method of attaching an item to a vehicle, comprising:
threading a stud recess of a lug nut about a threaded wheel stud;
rotating a head of a lug bolt for threading a threaded portion of the lug bolt into a bolt recess of the lug nut;
affixing the position of the lug bolt relative to the lug nut by rotating a lock nut about the threaded portion and into engagement with the lug nut;
repeating the previous three steps for additional lug nuts and additional lug bolts;
rotating a rotatable portion of each of the lug bolts for aligning an aperture defined by the rotatable portion with a corresponding arcuate slot defined by a plate;
securing the plate to the lug bolts by inserting a plate fastener through each arcuate slot and the corresponding aperture for securing the plate to the vehicle.

18. The method of claim 17, wherein rotating the head of the lug bolt includes engaging the threaded portion of the lug bolt with an extension recess of an extension, the extension defining an extension bolt engaged with the bolt recess of the lug nut.

19. The method of claim 17, further comprising securing a safety wheel to the plate by inserting a wheel fastener through each of a plurality of wheel apertures and each of a corresponding plate aperture.

20. The method of claim 17, further comprising:
securing an attachment to a center of the plate and extending substantially perpendicular therefrom,
wherein an arm is coupled to the attachment and extending substantially parallel to the plate,
wherein an accessory is carried by the arm,
wherein the coupling of the arm and the attachment permits free rotation of the arm in relation to the attachment.
